(19) United States
(12) Patent Application Publication
(10) Pub. No.: US 2025/0343632 A1
(43) Pub. Date: Nov. 6, 2025

(54) SYSTEMS, METHODS, AND DEVICES FOR AGGREGATED SIDELINK FEEDBACK

(71) Applicant: Apple Inc., Cupertino, CA (US)

(72) Inventors: Hong He, San Jose, CA (US); Chunxuan Ye, San Diego, CA (US); Dawei Zhang, Saratoga, CA (US); Wei Zeng, Saratoga, CA (US); Haitong Sun, Saratoga, CA (US); Huaning Niu, San Jose, CA (US); Weidong Yang, San Diego, CA (US); Oghenekome Oteri; Yushu Zhang, Beijing (CN); Zhibin Wu, Los Altos, CA (US)

(21) Appl. No.: 18/860,743

(22) PCT Filed: Apr. 29, 2022
(86) PCT No.: PCT/CN2022/090678

§ 371 Date: Oct. 28, 2024

(51) Int. Cl. H04L 1/1812; H04L 5/00; H04W 72/0457; H04W 72/25; H04W 72/40; H04W 76/20; H04W 92/18

(52) U.S. Cl. CPC H04L 1/1812; H04L 5/0053; H04W 72/0457; H04W 72/25; H04W 72/40; H04W 76/20; H04W 92/18

(57) ABSTRACT

Techniques, described herein, may enable a user equipment (UE) to use multiple sidelink (SL) carriers to send information to another UE, and for feedback regarding reception of the information to be communicated via a single SL carrier.

### FIELD

This disclosure relates to wireless communication networks including techniques for sidelink (SL) communications in a wireless communication network.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes enabling user equipment (UE) to communicate directly with one another via sidelink (SL) communications.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example overview of aggregated sidelink (SL) feedback according to one or more implementations described herein.

FIG. 2 is a diagram of an example network according to one or more implementations described herein.

FIG. 3 is a diagram of an example process for aggregated SL feedback according to one or more implementations described herein.

FIGS. 4-8 are diagrams of examples of physical shared feedback channel (PSFCH) resources aggregated SL feedback according to one or more implementations described herein.

FIG. 9 is a diagram of an example process for providing aggregated SL feedback according to one or more implementations described herein.

FIG. 10 is a diagram of an example process for retransmitting data in response to aggregated SL feedback according to one or more implementations described herein.

FIG. 11 is a diagram of an example of components of a device according to one or more implementations described herein.

FIG. 12 is a diagram of example interfaces of baseband circuitry according to one or more implementations described herein.

FIG. 13 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs may be capable of communicating and connecting with one another directly. Direct communications between UEs may be referred to as device-to-device (D2D) communications, vehicle-to-anything (V2X) communications, sidelink (SL) communications, and so on. UEs may use one or more wireless frequency bands to communicate with different wireless devices, including a licensed frequency band and an unlicensed frequency band.

UEs may implement carrier aggregation (CA) to use multiple carriers to communicate with one another. In such scenarios, a single synchronization reference signal may be used to synchronize transmission and reception of the carriers. In some implementations, higher layer signaling may be used to configure a set of carriers (e.g., Set A) that may be potentially used for carrier synchronization. When Set A is empty, independent synchronization may be used per carrier. When Set A is not empty, then Set A is a subset of the set of potential carriers configured for transmission (Tx) and reception (Rx) for CA, and a UE may determine an available set of synchronization carriers (e.g., Set B) as a subset of Set-A based on which carriers are being selected for CA. When Set B is empty, independent synchronization may be used per carrier. When Set B includes only one potential synchronization carrier, the UE may derive a time and frequency of the aggregated carriers from the synchronization reference of the synchronization carrier. When Set B includes multiple potential synchronization carriers, the UE may select a carrier from Set B with the highest priority synchronization reference.

A SL synchronization signal (SLSS) may be used to synchronize Tx and Rx SL communications. In such scenarios, a UE may assume that a number and location of SLSS resources is the same for all aggregated carriers. The UE may be configured to the SLSS on a synchronization carrier selected from Set B. Alternatively, UE may be configured to a SSLS on all carriers of Set B. When synchronization is lost, a new synchronization carrier may be reelected and used by the UE to re-establish synchronization.

A UE may perform SL resource selection to identify and reserve carriers and other resources for communicating with another UE. In some implementations, SL resource selection may be configured or specified by the network (e.g., a base station). In other implementations, the UE may select SL resources from a pre-defined pool of SL resources. When random selection is configured by upper layers, resources within a selection window of a resource pool are considered as a candidate resource set. In some implementations, a UE may be of limited capacity (e.g., limited Tx ability), and therefore be unable to support or select certain resources. Limited TX capability may mean that the UE cannot support transmission(s) over carrier(s) in a subframe due to one or more factors, such as: a number of Tx chains being smaller than a number of configured Tx carriers; the UE not supporting a given band combination; a Tx chain switching time; etc. When a limited capacity UE performs resource selection for a certain carrier, any subframe of that carrier shall be excluded from the reported candidate resource set if using that subframe would exceed a Tx capability limitation under the given resource reservation in the other carriers. Additionally, or alternatively, if a per-carrier independent resource selection leads to transmissions beyond the Tx capability of the UE in a subframe, the UE may re-perform resource reselection within the provided candidate resource set until the resultant transmission resources can be supported by the UE.

Additionally, the PSFCH may be implemented in a sequence-based short format (e.g., a sequence of a physical UL control channel (PUCCH) format 0). Time resources may be repetitions of the PSFCH format to two consecutive symbols. The first symbol may be used for automatic gain control (AGC) training. AGC training may include adjusting a gain output to handle a strong incoming signal and provide maximum coverage area within the building or other area. AGC training may continually adjust the signal output to keep a booster working at peak performance. In a strong signal environments, the booster may reduce its gain for each frequency spectrum individually as to not overload or shut down, thus making for a great coverage area inside. The other symbol may be used for GAP (e.g., Tx/Rx switch) after a PSFCH transmission. GAP may refer to a gap or spacing in resource between Tx/Rx switching and/or DL/UL switching.
gaps are opportunities given to the UE to perform measurements on downlink signals. A UE can't perform inter-frequency or inter-RAT measurements while also transmitting or receiving. Even for intra-frequency measurements, a 5G UE may require measurement gaps if such measurements are to be performed outside the UE's currently active Bandwidth Part (BWP)

Additionally, only 1 physical resource block (PRB) may be used by the PSFCH instead of, for example, the entire sub-channel being used.

In terms of resources, each PSFCH may be mapped to a time, frequency, and code resource. The time domain resource may be offset by 2-3 slots from a corresponding physical SL shared channel (PSSCH). A PSFCH may be part of a resource pool preconfigured for potential PSFCH resources. The frequency domain resource may be determined based on a corresponding PSSCH starting sub-channel index and slot index. And the code domain resource may be used for groupcast HARQ feedback.

However, while current SL communications technology may provide some features or aspects helpful to enable SL communications, the currently available technology includes one or more deficiencies. For example, current SL communications technology fail to provide adequate (or any) solutions relating to implementing SL CA with SL HARQ feedback procedures that are organized or efficient in terms of which PSFCH resources are to be used for HARQ feedback, how selected PSFCH resources may be mapped to SL CA resources, or how to enable SL HARQ feedback in unicast and/or groupcast scenarios.

The techniques described herein provide solutions to enabling UEs to perform HARQ procedures, during SL communications, in organized and efficient manner. For example, one or more of the techniques described herein many enable a UE to receive SL communications via aggregated SL carriers and use only a single SL carrier (e.g., a PSFCH) to provide SL HARQ feedback (e.g., an acknowledgement (ACK) or negative acknowledgement (NACK)) for all of the aggregated SL carriers. In such implementations, the SL HARQ feedback may be transmitted in a single carrier that may be referred to as an SL PSFCH primary cell or SL PSFCH primary resource pool. The SL PSFCH primary cell may be determined by a pre-defined rule (e.g., a PSSCH transmission may use the aggregated SL carriers and the CL carrier with the lowest carrier identifier (ID) may be the SL PSFCH primary cell). In another the SL PSFCH primary cell may be (implicitly or explicitly) determined or indicated based on a resource pool pre-configuration or bandwidth part (BWP) pre-configuration, which may be from an original equipment manufacturer (OEM). In another example, an SL PSFCH primary cell may be configured via PC5 radio resource control (PC5-RRC) information (e.g., via capability information, dedicated SL carrier aggregation information, etc.). In some implementations, an SL PSFCH primary cell may also, or alternatively, by dynamically indicated via SL control information (SCI).

One or more of the techniques described herein may further provide solutions for determining a total number of PSFCH resources and mapping aggregated SL carriers to specific PSFCH resources (e.g., physical resource blocks (PRBs)). One or more of the techniques described herein may further provide solutions for reporting HARQ feedback for unicast SL communications, groupcast SL communications with ACK/NACK feedback, and groupcast SL communications with only NACK feedback. As such, the techniques, described herein, provide several enhancements, improvements, and entirely new features to aggregating and communicating SL feedback.

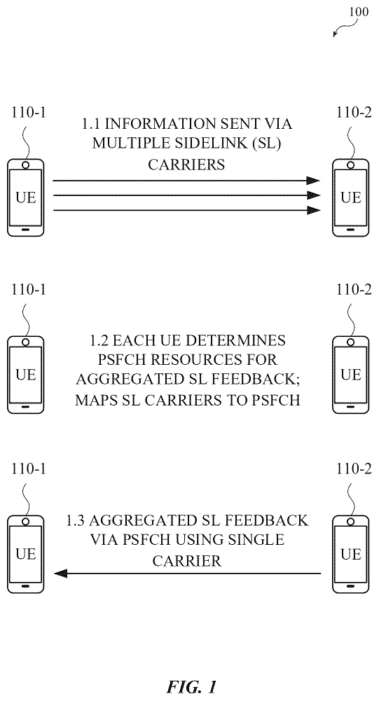

FIG. 1 is a diagram of an example overview 100 of aggregated SL feedback according to one or more implementations described herein. As shown, UE 110-1 may communicate information to UE 110-1 via multiple SL carriers (at 1.1). In preparation to providing aggregated SL feedback, UE 110-1 and UE 110-2 may each determine PSFCH resources for sending aggregated SL feedback for the communications via multiple SL carriers (at 1.2). This may include mapping the multiple SL carriers to resources of a single PSFCH carrier. Additionally, as described herein, aggregated SL feedback may include a HARQ message, such as an HARQ ACK message or a HARQ NACK message regarding a reception success or failure of the information communicated via the multiple SL carriers. Determining the PSFCH resources for sending aggregated SL feedback may help ensure that UE 110-2 communicates the aggregated SL feedback to UE 110-2 using PSFCH resources that UE 110-1 may be monitoring for said feedback. Accordingly, UE 110-2 may send UE 110-1 aggregated SL feedback, regarding the information sent via the multiple SL carriers, using PSFCH resources on a single carrier (at 1.3). In this manner, one or more of the techniques described herein may enable a UE to use multiple SL carriers to send information to another UE, and for feedback regarding reception of the information to be communicated via a single SL carrier. Details of such techniques, and/or others, are described in greater detail with reference to the Figures below.

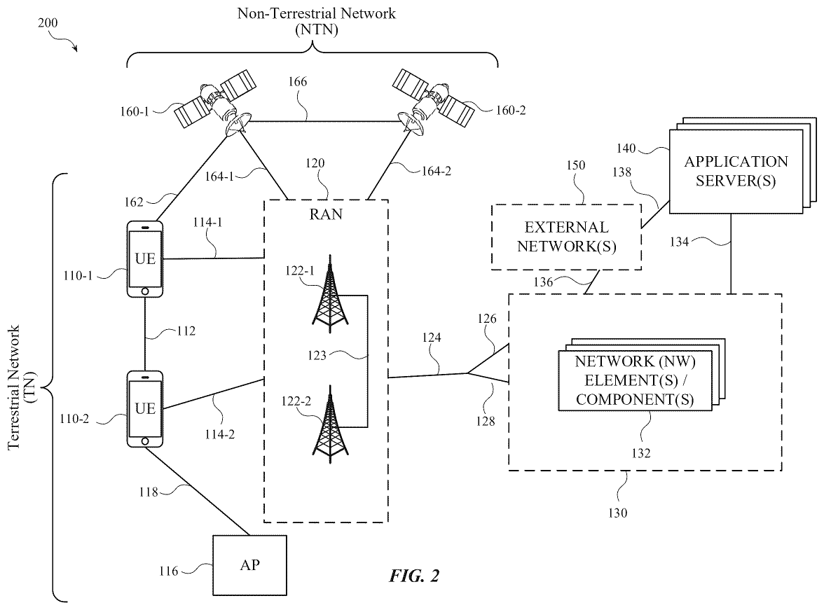

FIG. 2 is an example network 200 according to one or more implementations described herein. Example network 200 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 200 may include a non-terrestrial network (NTN) comprising one or more satellites 160 (e.g., of a global navigation satellite system (GNSS)) in communication with UEs 110 and RAN 120.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe), device-to-device (D2D) communications, or vehicle-to-everything (V2X) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, a V2X connection, etc. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

As described herein, UEs 110 may be configured to use wireless channels 112 to perform HARQ procedures, during SL communications, in organized and efficient manners. For example, one or more of the techniques described herein many enable UE 110 to receive SL communications via aggregated SL carriers and use only a single SL carrier (e.g., a PSFCH) to provide SL HARQ feedback (e.g., an acknowledgement (ACK) or negative acknowledgement (NACK)) for all of the aggregated SL carriers. In such implementations, the SL HARQ feedback may be transmitted in a single carrier that may be referred to as an SL PSFCH primary cell or SL PSFCH primary resource pool. The SL PSFCH primary cell may be determined by a pre-defined rule (e.g., a PSSCH transmission may use the aggregated SL carriers and the CL carrier with the lowest carrier identifier (ID) may be the SL PSFCH primary cell). Additional and alternative techniques and features for SL communications are also described herein.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 101, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 122.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 2, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and also to implementation where the base station, RAN node 122, etc., is a non-terrestrial network node (e.g., satellite 160).

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using NR unlicensed, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 200 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and implementation, where the base station, RAN node 122, etc., is a non-terrestrial network node (e.g., satellite 160). As described herein, UE 110 and base station 122 may communicate with one another, via interface 114, to enable enhanced power saving techniques.

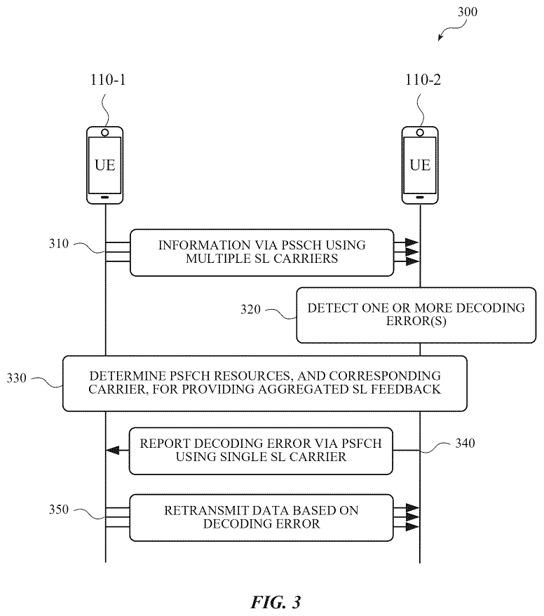

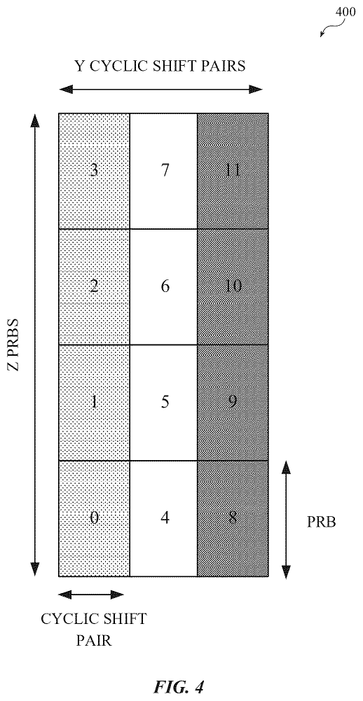

FIG. 3 is a diagram of an example process for aggregated SL feedback according to one or more implementations described herein. Process 300 may be implemented by UEs 110. In some implementations, some or all of process 300 may be performed by one or more other systems or devices, including one or more of the devices of FIG. 2. Additionally, process 300 may include one or more fewer, additional, differently ordered and/or arranged operations than those shown in FIG. 3. In some implementations, some or all of the operations of process 300 may be performed independently, successively, simultaneously, etc., of one or more of the other operations of process 300. As such, the techniques described herein are not limited to a number, sequence, arrangement, timing, etc., of the operations or process depicted in FIG. 3. Additionally, operations of FIG. 3 are described below with periodic reference to FIGS. 4-8.

As shown, UE 110-1 may use multiple SL carriers to send information to UE 110-2 via a PSSCH (at 310). The multiple SL carriers may correspond to a PSSCH. UE 110-2 may receive and analyze the information to determine whether a decoding error (or another type of information reception failure) has occurred. A decoding error, as described herein, may include a failure of one UE to receive information from another UE. For purpose of FIG. 3, assume that UE 110-2 determines that one or more decoding errors has occurred with respect to the information sent via the SL carriers (block 320). In some implementations, UE 110-2 may detect a single decoding error. In some implementations, UE 110-2 may determine multiple decoding errors. When UE 110-2 does not detect a decoding error, UE 110-2 may send an ACK message to UE 110-1 using any carrier, of the multiple or plurality of carriers used by UE 110-1 to send the information.

UE 110-1 and UE 110-2 may determine PSFCH resources, and a corresponding carrier, for providing aggregated SL feedback (block 330). In some implementations, this may include UE 110-1 and UE 110-2 mapping the multiple SL carriers to a single SL feedback carrier, or multiple SL feedback carriers that are nonetheless a subset of available SL feedback carriers, comprising PSFCH resources. In some implementations, UE 110-1 and UE 110-2 may determine PSFCH resources, and a corresponding carrier, for providing aggregated SL feedback after UE 110-1 communicates the information via the PSSCH. In some implementations, UE 110-1 and UE 110-2 may do so at another time. Additionally, or alternatively, UE 110-1 and UE 110-2 may do so at or around the same time (as depicted in FIG. 3); however, in other implementations, UE 110-1 and UE 110-2 may do so at different times.

In some implementations, the single carrier for transmitting SL HARQ feedback may be referred to as a SL PSFCH primary cell (or primary resource pool). In some implementations, determination of the SL PSFCH primary cell may include application of a pre-defined rule that may be provided to UE 110-1 and/or UE 110-2 from the network (e.g., base station 122) or shared among UEs 110. For example, each PSSCH carrier of the multiple carriers used to transmit data from UE 110-1 to UE 110-2 may include a carrier identifier (ID). In such scenarios, a rule may be applied for determining the SL PSFCH primary cell, such that a carrier with a described carrier ID (e.g., a lowest carrier ID) may be identified as the SL PSFCH primary cell for sending SL HARQ feedback. In some implementations, a resource pool pre-configuration, a resource pool configuration, an SL BWP pre-configuration, or an SL BWP pre-configuration may be used to determine the SL PSFCH primary cell. A resource pool pre-configuration or configuration, as described herein, may include a set or arrangement of carriers or resources aggregated to communicate information between UE 110-1 to UE 110-2. An SL BWP pre-configuration or configuration, as described herein, may include a set or arrangement, or multiple sets or arrangements, of resource blocks used for SL communications.

UE 110-1 and UE 110-2 may receive or access a resource pool pre-configuration or an SL BWP pre-configuration based on pre-stored configuration information (e.g., OEM information) on the device itself. UE 110-1 and UE 110-2 may receive a resource pool configuration or an SL BWP pre-configuration from the network (e.g., base station 122). The pre-configuration or configuration may explicitly or implicitly indicate whether the corresponding SL resource pool may be the SL PSFCH primary cell. For example, if/when a resource pool does not have PSFCH resources, UE 110 may determine that the resource pool cannot be a SL PSFCH primary cell for purposes of aggregate SL feedback. Additionally, or alternatively, if/when PSFCH resources of a resource pool pre-configuration has less than a threshold number of PRBs or a prospective PSFCH resource has larger than a threshold periodicity, UE 110 may determine that the resource pool cannot be a SL PSFCH primary cell for purposes of aggregate SL feedback. In some implementations, UE 110 may implement a combination of the foregoing criteria by, for example, determining which carriers of the resource pools qualify as potential candidates (e.g., threshold PRBs, periodicities, etc.) for being a SL PSFCH primary cell and then selecting among the potential candidates based on another criteria, such as which has the smallest carrier ID.

In some implementations, UE 110-1 and UE 110-2 may determine PSFCH resources, and a corresponding carrier, for providing aggregated SL feedback, based on a PC5-RRC configuration. In some implementations, The PC5-RRC configuration may be part of a capability information exchange among UEs 110. In some implementations, the PC5-RRC configuration may be exchanged between UEs 110 as part of dedicated SL carrier aggregation information. In some implementations, UE 110-1 and UE 110-2 may determine PSFCH resources, and a corresponding carrier, for providing aggregated SL feedback based on a dynamic indication. For example, SL control information (SCI) may be used to indicate whether a particular resource pool is to be used as a SL PSFCH primary cell.

In such implementations, a particular SCI format (e.g., Format 1-A) and one or more bits (e.g., a least significant bit (LSB)) of a reserved field may be used for dynamic indication of whether a particular resource pool is to be used as a SL PSFCH primary cell. In some implementations, whether an SL PSFC primary cell is to be dynamically indicated may be (pre) configured (e.g., determined by) the corresponding SL resource pool. In some implementations, a total number of potential PSFCH resources may be consistent with:

$${R}_{PRB , CS}^{PSFCH} = {N}_{type}^{PSFCH} \cdot {M}_{subch , slot}^{PSFCH} \cdot {N}_{CS}^{PSFCH} .$$

$${R}_{P RB , CS}^{P S F C H}$$

may be a number of PSFCH resources in terms of PRBs and cyclic shifts (CS).

$${N}_{type}^{P S F C H}$$

may be a number of PSFCH resources independent of a number of carriers; a number of PSFCH resources proportional to the number of carriers; or a number of PSFCH depending of the number of carriers; number of PSFCH channels.

$${N}_{CS}^{P S F C H}$$

may be a number of cyclic shift pairs for a corresponding resource pool (which may be indicated by an information element (IE) such as sl-PSFCH-RB-Set); and where:

$${M}_{s u b ch , slot}^{P S F C H} = {M}_{PRB , set}^{P S F C H} / ( {N}_{s u b c h} \cdot {N}_{P S S C H}^{P S F C H} ) . {M}_{P RB , set}^{P S F C H}$$

may be provided by an IE such as sl-PSFCH-RB-Set. N_{subch} may be a number of subchannels. And

$${N}_{P SSCH}^{P S F C H}$$

may be a number of potenual PSFCHs per PSSCH.

In some implementations, the total number of PSFCH resources may be independent of the number of carriers. In such implementations,

$${N}_{type}^{P S F C H}$$

may be equal to 1 or the number of subchannels per PSFCH

$$( e . g . , {N}_{s u b c h}^{P S F C H} ) ,$$

which may depend on a configuration presented by an IE, such as sl-PSFCH-CandidateResourceType. In some implementations, the total number of PSFCH resources may be proportional to the number of carriers aggregated. In such implementations,

$${N}_{type}^{P S F C H}$$

may be equal to the number of carriers aggregated

$$( e . g . , {N}_{C A}^{P S F C H} )$$

or

$${N}_{s u b c h}^{P S F C H} \cdot {N}_{C A}^{P S F C H} ,$$

which may depend on a configuration presented by an IE, such as sl-PSFCH-CandidateResourceType.

$${N}_{C A}^{P S F C H}$$

may be a maximum number of carriers for a PSFCH that is pre-configured to correspond to a primary resource pool. In some implementations, the total number of PSFCH resources may be dependent on the number of carriers aggregated. In such implementations,

$${N}_{type}^{P S F C H}$$

may be equal to 1,

$${N}_{CA}^{PSFCH} , {N}_{s u b c h}^{PSFCH} , or {N}_{s u b c h}^{PSFCH} \cdot {N}_{CA}^{PSFCH} ,$$

which may depend on a configuration presented by an IE, such as sl-PSFCH-CandidateResourceType.

UE 110-2 may report the decoding error via the PSFCH using a single SL carrier (block 340). For example, UE 110-2 may use the carrier previously determined to send a HARQ response (e.g., an ACK/NACK message) to UE 110-1. The ACK/NACK message may be an SL unicast transmission. In some implementations, multiple PSFCH resources may be used and each PSFCH resource may be associated with a SL carrier. In some implementations, different PSFCH resources may be separated in a frequency domain but not in a code domain.

FIGS. 4-8 are diagrams of examples 400, 500, 600, 700, and 800 (collectively referred to as examples 400-800) of PSFCH resources for aggregated SL feedback according to one or more implementations described herein. Each of examples 400-800 may include PSFCH resources, indexed from 0-11, which may be arranged by frequency first and cyclic shift second. Examples 400-800 present PSFCH resources 0-11 in terms of Y cyclic shift pairs arranged by Z physical resource blocks (PRBs). Referring to FIG. 4, for example, PSFCH resources 0, 1, 2, and 3 may correspond to a first cyclic shift pair; PSFCH resources 4, 5, 6, and 7 may correspond a second cyclic shirt pair; and PSFCH resources 8, 9, 10, and 11 may correspond to a third cyclic shift pair, respectively. Additionally, or alternatively, PSFCH resources 0, 4, and 8 may correspond to a first PRB, PSFCH resources 1, 5, and 9 may correspond to a second PRB, PSFCH resources 2, 6, and 10 may correspond to a third PRB, and PSFCH resources 3, 7, and 11 may correspond to a fourth PRB, respectively. As described below, PSFCH resources 0-11 may be arranged in different ways to provide for a single SL carrier for reporting aggregated SL feedback.

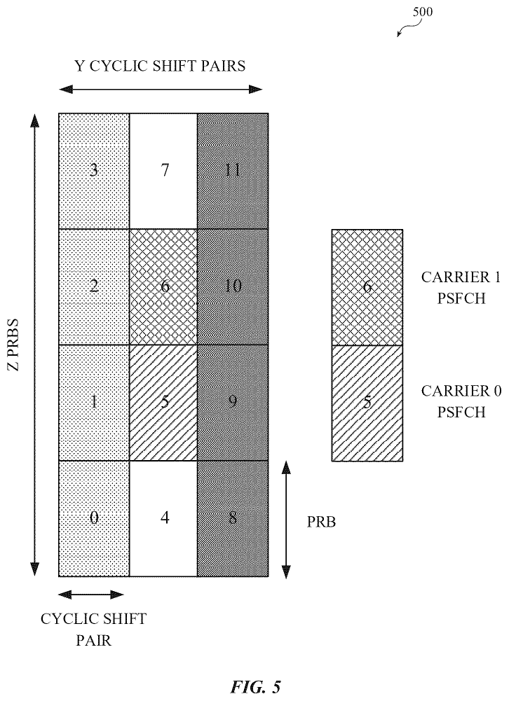

UEs 110 may determine an index of a PSFCH resource for a PSFCH transmission with HARQ-ACK information in response to a PSSCH reception on a SL carrier with a carrier ID (CID). As shown in FIG. 5, for example, the PSFCH resources may be centralized in accordance with:

$$( {P}_{ID} + {C}_{ID} ) mod {R}_{P RB , CS}^{P S F C H} ,$$

where P_{ID} may be a physical layer source ID, which may be included in SCI, and

$$mod {R}_{P RB , CS}^{P S F C H}$$

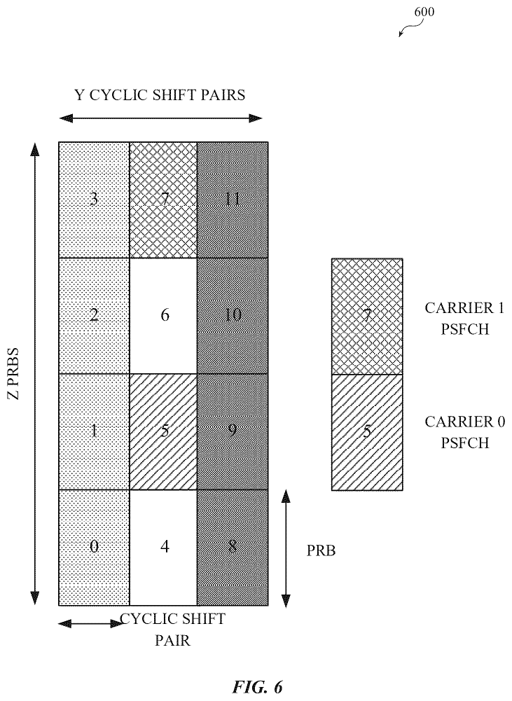

may be a modulo operation (e.g., represented on FIG. 4). As shown in FIG. 6, by contrast, the PSFCH resources may be distributed in accordance with:

$$( {P}_{ID} + {C}_{ID} \cdot ⌈ {M}_{s u bch , slot}^{P S F C H} / {T}_{C A} ⌉ ) mod {R}_{P RB , CS}^{P S F C H} or ( {P}_{ID} + {C}_{ID} \cdot ⌊ {M}_{s u b ch , slot}^{P S F C H} / {T}_{C A} ⌋ ) mod {R}_{P RB , CS}^{P S F C H} ,$$

where

$$⌈ {M}_{s u bch , slot}^{P S F C H} / {T}_{C A} ⌉$$

may be the ceiling operation,

$$⌊ {M}_{s u bch , slot}^{P S F C H} / {T}_{C A} ⌋$$

may be the floor operation where T_{CA} is a total number of SL carriers used for PSSCH transmissions, which may be the maximum number of SL carriers supported in a resource (N_{CA}) or may be the actual number of SL carriers used for data transmissions. T_{CA} may be indicated via SCI (e.g., SCI Format 1-A) using a reserved bit (e.g., LSB). T_{CA} may also, or alternatively, based on a PC5 configuration. This may be implemented as a ceiling operations (e.g., configured to round up) or a floor operation (e.g., an operation configured to round down).

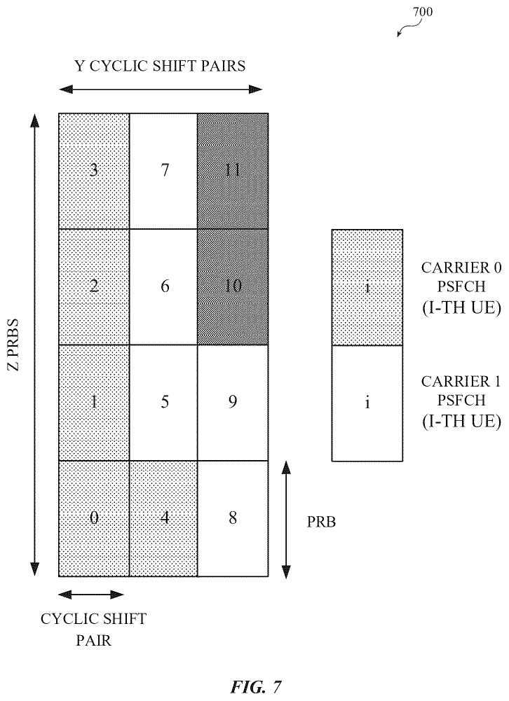

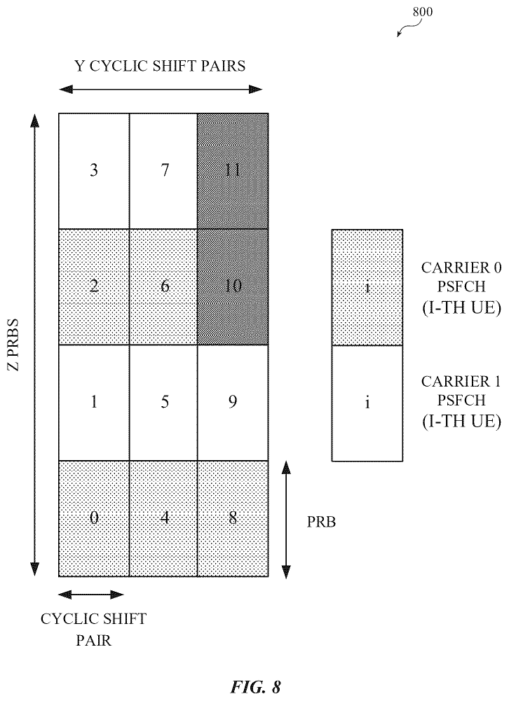

The ACK/NACK message may also, or alternatively, be an SL groupcast transmission. In such scenarios, multiple PSFCH resources may be used, and each PSFCH resource may be associated with a combination of an SL carrier and a group member UE. In some implementations, different PSFCH resources may be separated in a frequency domain but not in a code domain. Additionally, UEs 110 may determine an index of a PSFCH resource for a PSFCH transmission with HARQ-ACK information in response to a PSSCH reception on a SL carrier with a CD. As shown in FIG. 7, the PSFCH resources may be mapped in accordance with:

$$( {P}_{ID} + {M}_{ID} + {C}_{ID} * G ) mod {R}_{P RB , CS}^{P S F C H} ,$$

where M_{ID} is a group member ID of a Rx UE, and G is a total number of Rx UEs in the group. G may be a maximum number of Rx UEs supported in a group or an actual number of Rx UEs for data reception in the group. G may also be based on resource pool pre-configuration or dynamically indicated via SCI. Additionally, a group member ID first, carrier ID second rule may be applied. To describe such a rule, suppose there is a group of 2 Rx UEs (UE0 and UE1) and 2 carriers (CC0 and CC1), in such a scenario, 4 PSFCH resources may be used for the UEs to provide ACK/NACK feedback on 2 carriers (e.g., UE0 on CC0, UE0 on CC1, UE1 on CC0 and UE1 on CC1). If PSFCH resource A is for UE0 on CC0, then PSFCH resource A+1 may be for UE1 on CC0; if PSFCH resource A+2 is for UE0 on CC1, then PSFCH resource A+3 may be for (UE1 on CC1. This may be a first alternative (see, e.g., FIG. 7). Accordingly, the PSFCH resources may increases with group members, first on the same carrier, then with carrier ID. By contrast, if PSFCH resource A is for UE0 on CC0, then PSFCH resource A+1 may be for UE0 on CC1; and if PSFCH resource A+2 is for UE1 on CC0, then PSFCH resource A+3 may be for UE1 on CC1. This may be a second alternative (see, e.g., FIG. 8). Additionally, the PSFCH resource increases with carrier ID first on the same UE, then with next UE.

The example of FIG. 7 is provided with the assumption that G=5. As shown in FIG. 8, the PSFCH resources may be mapped in accordance with:

$$( {P}_{ID} + {M}_{ID} * {T}_{CA} + {C}_{ID} ) mod {R}_{P RB , CS}^{P S F C H} ,$$

where a group member ID first, carrier ID second rule may be applied and T_{CA} is the total number of SL carriers used for PSSCH transmissions. The example of FIG. 8 is provided with the assumption that G=5. In some implementations, one of the SL groupcast transmission approaches described above may also be used for SL unicast transmissions using G=1 and M_{ID}=0.

For purposes of explaining FIG. 3, assume that UE 110-2 communicates a HARQ NACK message to UE 110-1. The HARQ NACK message may indicate that a reception failure occurred regarding the information sent by UE 110-1 via the PSSCH using the multipole carriers. As shown, UE 110-1 may receive the aggregated SL feedback and respond by, for example, retransmitting the information based on the decoding error (at 350). Accordingly, one or more of the techniques described herein may enable a UE (e.g., UE 110-1) to use multiple SL carriers to send information to another UE (e.g., UE 110-2), and for feedback regarding reception of the information to be communicated via a single SL carrier. Details of such techniques, and/or others, are described in greater detail with reference to the Figures below.

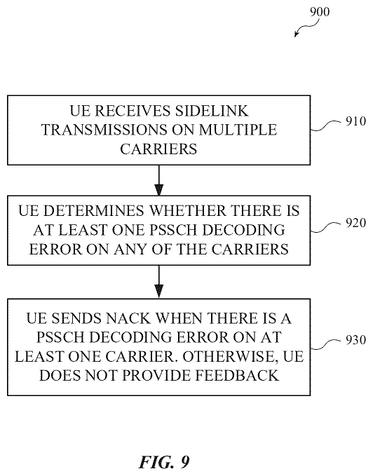

FIG. 9 is a diagram of an example process for providing aggregated SL feedback according to one or more implementations described herein. Process 900 may be implemented by UE 110. In some implementations, some or all of process 900 may be performed by one or more other systems or devices, including one or more of the devices of FIG. 2. Additionally, process 900 may include one or more fewer, additional, differently ordered and/or arranged operations than those shown in FIG. 9. In some implementations, some or all of the operations of process 900 may be performed independently, successively, simultaneously, etc., of one or more of the other operations of process 900. As such, the techniques described herein are not limited to a number, sequence, arrangement, timing, etc., of the operations or process depicted in FIG. 9.

As shown, UE 110 may receive SL transmissions via multiple carriers (block 910). UE 110 may determine whether there is at least one PSSCH decoding error on any of the carriers (block 920). And UE 110 may send a NACK message when there is a PSSCH decoding error on at least one carrier; otherwise, UE 110 may not provide any feedback (block 930).

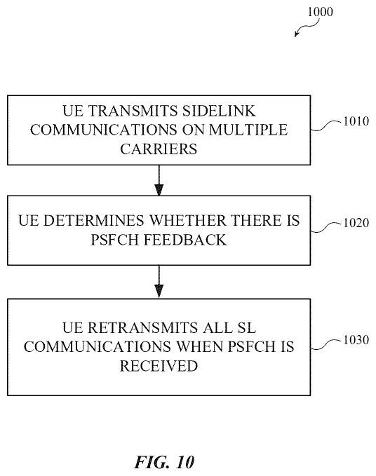

FIG. 10 is a diagram of an example process for retransmitting data in response to aggregated SL feedback according to one or more implementations described herein. Process 1000 may be implemented by UE 110. In some implementations, some or all of process 1000 may be performed by one or more other systems or devices, including one or more of the devices of FIG. 2. Additionally, process 1000 may include one or more fewer, additional, differently ordered and/or arranged operations than those shown in FIG. 10. In some implementations, some or all of the operations of process 1000 may be performed independently, successively, simultaneously, etc., of one or more of the other operations of process 1000. As such, the techniques described herein are not limited to a number, sequence, arrangement, timing, etc., of the operations or process depicted in FIG. 10.

As shown, UE 110 may transmit SL communications on multiple carriers (block 1010). UE may determine whether there is any PSFCH feedback regarding the SL communications (block 1020). And UE 110 may retransmit all of the SL communications when PSFCH is received (block 1030).

In a unicast scenario, UE 110 may determine a number of PSFCH resources available for multiplexing HARQ-ACK information in a PSFCH transmission as

$${R}_{P RB , CS}^{P S F C H} = {N}_{type}^{P S F C H} \cdot {M}_{s u bch , slot}^{P S F C H} \cdot {N}_{C S}^{P S F C H} ,$$

where

$${N}_{CS}^{P S F C H}$$

is a number of cyclic shift pairs for the resource pool provided by sl-NumMuxCS-Pair and, based on an indication by sl-PSFCH-CandidateResourceType, When sl-PSFCH-CandidateResourceType is configured as a starting sub-channel parameter (e.g., startSubCH),

$${N}_{type}^{P S F C H}$$

may be equal to

$${N}_{C A}^{P S F C H} ,$$

and the

$${M}_{s u bch , slot}^{P S F C H} \cdot {N}_{C A}^{P S F C H}$$

PRBs may be associated with a starting sub-channel of the corresponding PSSCH. When sl-PSFCH-CandidateResourceType is configured as an allocated sub-channel parameter (e.g., allocSubCH),

$${N}_{type}^{P S F C H}$$

may be equal to

$${N}_{s u b c h}^{P S S C H} \cdot {N}_{CA}^{PSFCH}$$

and the

$${N}_{s u b c h}^{P S S C H} \cdot {M}_{s u bch , slot}^{P S F C H} \cdot {N}_{C A}^{P S F C H}$$

PRBs may be associated with one or more sub-channels from the

$${N}_{s u b c h}^{P S S C H}$$

corresponding PSSCH.

In a groupcast scenario, UE 110 may determine an index of a PSFCH resource for a PSFCH transmission with HARQ-ACK information in response to a PSSCH reception or with conflict information corresponding to a reserved resource as

$$( {P}_{ID} + {M}_{ID} + {C}_{ID} \cdot G ) mod {R}_{P RB , CS}^{P S F C H} ,$$

where P_{ID} may be a physical layer source ID provided by SCI scheduling the PSSCH reception, or by SCI reserving the resource from another UE 110 to be provided with conflict information. For HARQ-ACK information, M_{ID} may be the identity of the UE 110 receiving the PSSCH as indicated by higher layers if the UE 110 detects SCI with a particular cast type indicator field value of 1 or 01; otherwise, M_{ID} may be zero. For conflict information, M_{ID} may be zero. C_{ID} may be the SL carrier ID for multi-carrier operations. Otherwise, C_{ID} may be zero. G may be the total number of Rx UEs in the group. In a groupcast scenario, a single NACK feedback may be used when a PSSCH decoding error is detected on any SL carrier, and a single PSFCH resource for HARQ feedback may be determined. Additionally, or alternatively, a single NACK feedback may be used for each SL carrier and the PSFCH resource determination may be performed as described herein (e.g., by resource pool pre-configuration, SL BWP pre-configuration, etc.).

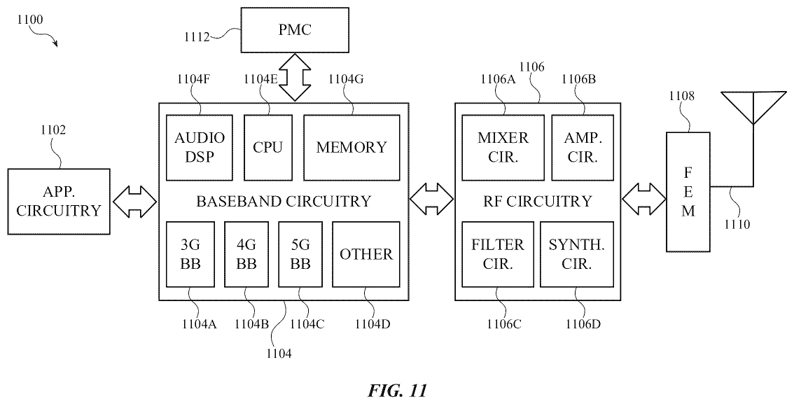

FIG. 11 is a diagram of an example of components of a device according to one or more implementations described herein. In some implementations, the device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. The components of the illustrated device 1100 can be included in a UE or a RAN node. In some implementations, the device 1100 can include fewer elements (e.g., a RAN node may not utilize application circuitry 1102, and instead include a processor/controller to process IP data received from a CN such as 5GC 130 or an Evolved Packet Core (EPC)). In some implementations, the device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for Cloud-RAN (C-RAN) implementations).

The components of the device of FIG. 11 may be configured and used to enable UEs 110 to use wireless channels 112 to perform HARQ procedures, during SL communications, in organized and efficient manners. For example, components (e.g., processors, memory, and interfaces) of the device of FIG. 11 many enable UE 110 to receive SL communications via aggregated SL carriers and use only a single SL carrier (e.g., a PSFCH) to provide SL HARQ feedback (e.g., an ACK) or NACK) for all of the aggregated SL carriers. In such implementations, the SL HARQ feedback may be transmitted in a single carrier that may be referred to as an SL PSFCH primary cell or SL PSFCH primary resource pool. The SL PSFCH primary cell may be determined by a pre-defined rule (e.g., a PSSCH transmission may use the aggregated SL carriers and the CL carrier with the lowest carrier ID may be the SL PSFCH primary cell. Additional and alternative techniques and features for SL communications are also described herein.

The application circuitry 1102 can include one or more application processors. For example, the application circuitry 1102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1100. In some implementations, processors of application circuitry 1102 can process IP data packets received from an EPC.

The baseband circuitry 1104 can include circuitry such as, but not limited to, one or more single-core or multi-core processors. The baseband circuitry 1104 can include one or more baseband processors or control logic to process baseband signals received from a receive signal path of the RF circuitry 1106 and to generate baseband signals for a transmit signal path of the RF circuitry 1106. Baseband circuity 1104 can interface with the application circuitry 1102 for generation and processing of the baseband signals and for controlling operations of the RF circuitry 1106. For example, in some implementations, the baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 2G, 6G, etc.). The baseband circuitry 1104 (e.g., one or more of baseband processors 1104A-D) can handle various radio control functions that enable communication with one or more radio networks via the RF circuitry 1106. In other implementations, some or all of the functionality of baseband processors 1104A-D can be included in modules stored in the memory 1104G and executed via a Central Processing Unit (CPU) 1104E. The radio control functions can include, but are not limited to, signal modulation/demodulation, encoding/decoding, radio frequency shifting, etc. In some implementations, modulation/demodulation circuitry of the baseband circuitry 1104 can include Fast-Fourier Transform (FFT), precoding, or constellation mapping/de-mapping functionality. In some implementations, encoding/decoding circuitry of the baseband circuitry 1104 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1104 can include one or more audio digital signal processor(s) (DSP) 1104F. The audio DSPs 1104F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1104 and the application circuitry 1102 can be implemented together such as, for example, on a system on a chip (SOC).

In some implementations, the baseband circuitry 1104 can provide for communication compatible with one or more radio technologies. For example, in some implementations, the baseband circuitry 1104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1104 is configured to support radio communications of more than one wireless protocol can be referred to as multi-mode baseband circuitry.

RF circuitry 1106 can enable communication with wireless networks using modulated electromagnetic radiation through a non-solid medium. In various implementations, the RF circuitry 1106 can include switches, filters, amplifiers, etc. to facilitate the communication with the wireless network. RF circuitry 1106 can include a receive signal path which can include circuitry to down-convert RF signals received from the FEM circuitry 1108 and provide baseband signals to the baseband circuitry 1104. RF circuitry 1106 can also include a transmit signal path which can include circuitry to up-convert baseband signals provided by the baseband circuitry 1104 and provide RF output signals to the FEM circuitry 1108 for transmission.

In some implementations, the receive signal path of the RF circuitry 1106 can include mixer circuitry 1106A, amplifier circuitry 1106B and filter circuitry 1106C. In some implementations, the transmit signal path of the RF circuitry 1106 can include filter circuitry 1106C and mixer circuitry 1106A. RF circuitry 1106 can also include synthesizer circuitry 1106D for synthesizing a frequency for use by the mixer circuitry 1106A of the receive signal path and the transmit signal path. In some implementations, the mixer circuitry 1106A of the receive signal path can be configured to down-convert RF signals received from the FEM circuitry 1108 based on the synthesized frequency provided by synthesizer circuitry 1106D. The amplifier circuitry 1106B can be configured to amplify the down-converted signals and the filter circuitry 1106C can be a low-pass filter (LPF) or band-pass filter (BPF) configured to remove unwanted signals from the down-converted signals to generate output baseband signals. Output baseband signals can be provided to the baseband circuitry 1104 for further processing. In some implementations, the output baseband signals can be zero-frequency baseband signals, although this is not a requirement. In some implementations, mixer circuitry 1106A of the receive signal path can comprise passive mixers, although the scope of the implementations is not limited in this respect.

In some implementations, the mixer circuitry 1106A of the transmit signal path can be configured to up-convert input baseband signals based on the synthesized frequency provided by the synthesizer circuitry 1106D to generate RF output signals for the FEM circuitry 1108. The baseband signals can be provided by the baseband circuitry 1104 and can be filtered by filter circuitry 1106C.

In some implementations, the mixer circuitry 1106A of the receive signal path and the mixer circuitry 1106A of the transmit signal path can include two or more mixers and can be arranged for quadrature down conversion and up conversion, respectively. In some implementations, the mixer circuitry 1106A of the receive signal path and the mixer circuitry 1106A of the transmit signal path can include two or more mixers and can be arranged for image rejection (e.g., Hartley image rejection). In some implementations, the mixer circuitry 1106A of the receive signal path and the mixer circuitry 906A can be arranged for direct down conversion and direct up conversion, respectively. In some implementations, the mixer circuitry 1106A of the receive signal path and the mixer circuitry 1106A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1106 can include analog-to-digital converter (ADC) and digital-to-analog converter (DAC) circuitry and the baseband circuitry 1104 can include a digital baseband interface to communicate with the RF circuitry 1106.

In some dual-mode implementations, a separate radio IC circuitry can be provided for processing signals for each spectrum, although the scope of the implementations is not limited in this respect.

In some implementations, the synthesizer circuitry 1106D can be a fractional-N synthesizer or a fractional N/N+1 synthesizer, although the scope of the implementations is not limited in this respect as other types of frequency synthesizers can be suitable. For example, synthesizer circuitry 1106D can be a delta-sigma synthesizer, a frequency multiplier, or a synthesizer comprising a phase-locked loop with a frequency divider.

The synthesizer circuitry 1106D can be configured to synthesize an output frequency for use by the mixer circuitry 1106A of the RF circuitry 1106 based on a frequency input and a divider control input. In some implementations, the synthesizer circuitry 1106D can be a fractional N/N+1 synthesizer.

In some implementations, frequency input can be provided by a voltage controlled oscillator (VCO), although that is not a requirement. Divider control input can be provided by either the baseband circuitry 1104 or the applications circuitry 1102 depending on the desired output frequency. In some implementations, a divider control input (e.g., N) can be determined from a look-up table based on a channel indicated by the applications circuitry 1102.

Synthesizer circuitry 1106D of the RF circuitry 1106 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1106 can include an IQ/polar converter.

FEM circuitry 1108 can include a receive signal path which can include circuitry configured to operate on RF signals received from one or more antennas 1110, amplify the received signals and provide the amplified versions of the received signals to the RF circuitry 1106 for further processing. FEM circuitry 1108 can also include a transmit signal path which can include circuitry configured to amplify signals for transmission provided by the RF circuitry 1106 for transmission by one or more of the one or more antennas 1110. In various implementations, the amplification through the transmit or receive signal paths can be done solely in the RF circuitry 1106, solely in the FEM circuitry 1108, or in both the RF circuitry 1106 and the FEM circuitry 1108.

In some implementations, the FEM circuitry 1108 can include a Tx/Rx switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1106). The transmit signal path of the FEM circuitry 1108 can include a power amplifier (PA) to amplify input RF signals (e.g., provided by RF circuitry 1106), and one or more filters to generate RF signals for subsequent transmission (e.g., by one or more of the one or more antennas 1110).

In some implementations, the PMC 1112 can manage power provided to the baseband circuitry 1104. In particular, the PMC 1112 can control power-source selection, voltage scaling, battery charging, or DC-to-DC conversion. The PMC 1112 can often be included when the device 1100 is capable of being powered by a battery, for example, when the device is included in a UE. The PMC 1112 can increase the power conversion efficiency while providing desirable implementation size and heat dissipation characteristics.

While FIG. 11 shows the PMC 1112 coupled only with the baseband circuitry 1104. However, in other implementations, the PMC 1112 may be additionally or alternatively coupled with, and perform similar power management operations for, other components such as, but not limited to, application circuitry 1102, RF circuitry 1106, or FEM circuitry 1108.

In some implementations, the PMC 1112 can control, or otherwise be part of, various power saving mechanisms of the device 1100. For example, if the device 1100 is in an RRC_Connected state, where it is still connected to the RAN node as it expects to receive traffic shortly, then it can enter a state known as Discontinuous Reception Mode (DRX) after a period of inactivity. During this state, the device 1100 can power down for brief intervals of time and thus save power.

If there is no data traffic activity for an extended period of time, then the device 1100 can transition off to an RRC_Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1102 and processors of the baseband circuitry 1104 can be used to execute elements of one or more instances of a protocol stack. For example, processors of the baseband circuitry 1104, alone or in combination, can be used execute Layer 3, Layer 2, or Layer 1 functionality, while processors of the baseband circuitry 1104 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

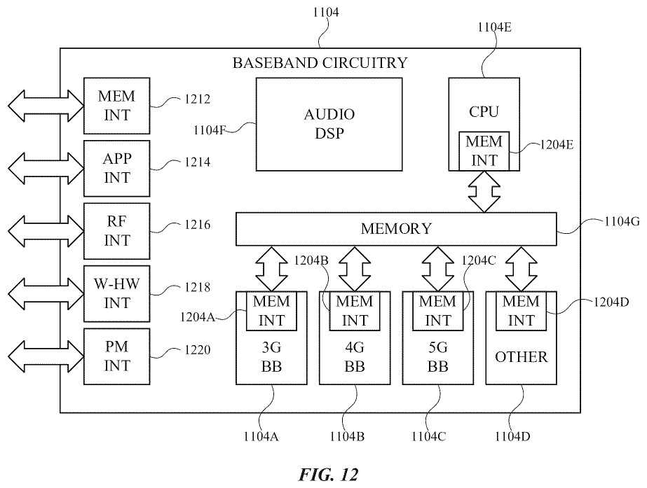

FIG. 12 is a diagram of example interfaces of baseband circuitry according to one or more implementations described herein. As discussed above, the baseband circuitry 1104 of FIG. 11 can comprise processors 1104A-E and a memory 1104G utilized by said processors. Each of the processors 1104A-E can include a memory interface, 1204A-E, respectively, to send/receive data to/from the memory 1104G. One or more of processors 1104A-E, memory interface, 1204A-E, memory 1104G, memory interface 1204E, and CPU 1104E may be used for transmitting/receiving the SL communications, for processing the SL communications and/or feedback for the SL communications, and for storing instructions for the operations described herein.

The baseband circuitry 1104 can further include one or more interfaces to communicatively couple to other circuitries/devices, such as a memory interface 1212 (e.g., an interface to send/receive data to/from memory external to the baseband circuitry 1104), an application circuitry interface 1214 (e.g., an interface to send/receive data to/from the application circuitry 1102 of FIG. 11), an RF circuitry interface 1216 (e.g., an interface to send/receive data to/from RF circuitry 1106 of FIG. 11), a wireless hardware connectivity interface 1218 (e.g., an interface to send/receive data to/from Near Field Communication (NFC) components, Bluetooth® components (e.g., Bluetooth® Low Energy), Wi-Fi® components, and other communication components), and a power management interface 1220 (e.g., an interface to send/receive power or control signals to/from the PMC 1112).

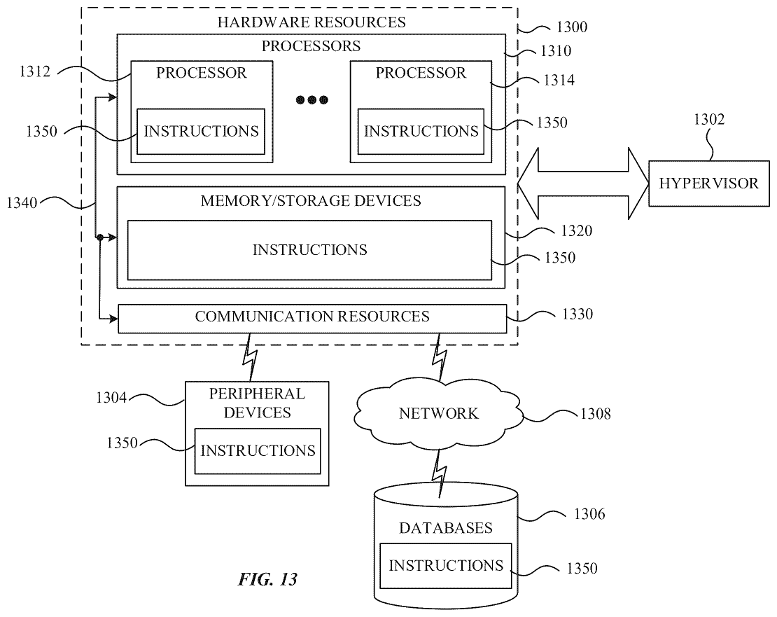

FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For embodiments where node virtualization (e.g., NFV) is utilized, a hypervisor 1302 may be executed to provide an execution environment for one or more network slices/sub-slices to utilize the hardware resources 1300

Processors 1310, instructions 1350, memory storage devices 1320, instructions, communication resources 1330, and one or more additional or alternative components of device 1300 may be used for transmitting/receiving the SL communications, for processing the SL communications and/or feedback for the SL communications, and for storing instructions for the operations described herein.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may include main memory, disk storage, or any suitable combination thereof. The memory/storage devices 1320 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a baseband processor, of a user equipment (UE), may comprising: one or more processors configured to: receive a sidelink (SL) communication via a plurality of carriers; detect a decoding error corresponding to at least one carrier of the plurality of carriers; determine physical SL feedback channel (PSFCH) resources, on a single carrier, for providing hybrid automatic repeat request (HARQ) feedback regarding the decoding error; and communicate the HARQ feedback using the PSFCH resources. In example 2, which may also include one or more of the examples described herein, the one or more processors are further configured to: receive a retransmission of the SL communication, via the plurality of carriers, in response to communicating the HARQ feedback.

In example 3, which may also include one or more of the examples described herein, the PSFCH resources are an SL PSFCH primary cell that is determined based on a pre-defined rule. In example 4, which may also include one or more of the examples described herein, the PSFCH resources are an SL PSFCH primary cell that is determined based on a resource pool configuration or bandwidth part (BWP) configuration. In example 5, which may also include one or more of the examples described herein, the PSFCH resources are an SL PSFCH primary cell that is determined based on PC5 radio resource control (PC5-RRC) information.

In example 6, which may also include one or more of the examples described herein, the PSFCH resources are an SL PSFCH primary cell that is determined based on SL control information (SCI). In example 7, which may also include one or more of the examples described herein, the PSFCH resources are determined based on a total number of PSFCH resources independent of a number of the plurality of carriers. In example 8, which may also include one or more of the examples described herein, the PSFCH resources are determined based on a total number of PSFCH resources proportional to a number of the plurality of carriers.

In example 9, which may also include one or more of the examples described herein, the PSFCH resources are determined based on a total number of PSFCH resources depending on a number of the plurality of carriers. In example 10, which may also include one or more of the examples described herein, SL communication is a unicast communication, and the PSFCH resources are each mapped from the at least one carrier, of the plurality of carriers, to a corresponding PSFCH resource based on a carrier identifier (ID) of the at least one carrier. In example 11, which may also include one or more of the examples described herein, SL communication is a groupcast communication with acknowledgement (ACK)/negative acknowledgement (NACK) feedback, and the PSFCH resources are each mapped from the at least one carrier, of the plurality of carriers, to a corresponding PSFCH resource based on based on a carrier identifier (ID) of the at least one carrier and a number of member UEs receiving the groupcast communication.

In example 12, which may also include one or more of the examples described herein, the SL communication is a groupcast communication, the HARQ feedback is a single negative acknowledgement (NACK) only transmission for decoding errors on any of the plurality of carriers. In example 13, which may also include one or more of the examples described herein, the SL communication is a groupcast communication, the HARQ feedback is a negative acknowledgement (NACK) only transmission configured to provide decoding errors on any of the plurality of carriers. In example 14, which may also include one or more of the examples described herein, a HARQ acknowledgement (ACK) message is communicated via any carrier of the plurality of carriers when the decoding error is not detected.

In example 15, which may also include one or more of the examples described herein, a user equipment (UE) may comprising: a memory configured to storing instructions; one or more processors configured, execute the instructions, to: transmit a sidelink (SL) communication to another UE via a plurality of carriers; determine physical SL feedback channel (PSFCH) resources, on a single carrier, for receiving hybrid automatic repeat request (HARQ) feedback regarding the SL communication; receive the HARQ feedback via the SL PSFCH resources; and re-transmit the SL communications, via the plurality of carriers, in response to the HARQ feedback. In example 16, which may also include one or more of the examples described herein, the PSFCH resources are an SL PSFCH primary cell that is determined based on a pre-defined rule.

In example 17, which may also include one or more of the examples described herein, the PSFCH resources are an SL PSFCH primary cell that is determined based on a resource pool pre-configuration or bandwidth part (BWP) pre-configuration. In example 18, which may also include one or more of the examples described herein, the PSFCH resources are an SL PSFCH primary cell that is determined based on a resource pool pre-configuration or bandwidth part (BWP) pre-configuration. In example 19, which may also include one or more of the examples described herein, the PSFCH resources are determined based on a total number of PSFCH resources and a number of the plurality of carriers.

In example 20, which may also include one or more of the examples described herein, a method, performed by a used equipment (UE), the method may comprise: transmitting a sidelink (SL) communication to another UE via a plurality of carriers; determining physical SL feedback channel (PSFCH) resources, on a single carrier, for receiving hybrid automatic repeat request (HARQ) feedback regarding the SL communication; receiving the HARQ feedback via the SL PSFCH resources; and re-transmitting the SL communications, via the plurality of carriers, in response to the HARQ feedback. In example 21, which may also include one or more of the examples described herein, the PSFCH resources are an SL PSFCH primary cell that is determined based on a pre-defined rule.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor configured to, when executing instructions stored in a memory, perform operations comprising:
receiving a sidelink (SL) communication via a plurality of carriers;
detecting a decoding error corresponding to at least one carrier of the plurality of carriers;
determining physical SL feedback channel (PSFCH) resources on a single carrier for providing hybrid automatic repeat request (HARQ) feedback associated with the decoding error; and
providing, to a radio frequency (RF) interface for transmission, the HARQ feedback using the PSFCH resources.

2. The baseband processor of claim 1, wherein the operations further comprise:
receiving a retransmission of the SL communication via the plurality of carriers in response to providing the HARQ feedback.

3. The baseband processor of claim 1, wherein the PSFCH resources are an SL PSFCH primary cell that is determined based on a pre-defined rule.

4. The baseband processor of claim 1, wherein the PSFCH resources are an SL PSFCH primary cell that is determined based on a resource pool configuration or bandwidth part (BWP) configuration.

5. The baseband processor of claim 1, wherein the PSFCH resources are an SL PSFCH primary cell that is determined based on PC5 radio resource control (PC5-RRC) information.

6. The baseband processor of claim 1, wherein the PSFCH resources are an SL PSFCH primary cell that is determined based on SL control information (SCI).

7. The baseband processor of claim 1, wherein the PSFCH resources are determined based on a total number of PSFCH resources independent of a number of the plurality of carriers.

8. The baseband processor of claim 1, wherein the PSFCH resources are determined based on a total number of PSFCH resources proportional to a number of the plurality of carriers.

9. The baseband processor of claim 1, wherein the PSFCH resources are determined based on a total number of PSFCH resources depending on a number of the plurality of carriers.

10. The baseband processor of claim 1, wherein SL communication is a unicast communication, and the PSFCH resources are each mapped from the at least one carrier, of the plurality of carriers, to a corresponding PSFCH resource based on a carrier identifier (ID) of the at least one carrier.

11. The baseband processor of claim 1, wherein SL communication is a groupcast communication with acknowledgement (ACK)/negative acknowledgement (NACK) feedback, and the PSFCH resources are each mapped from the at least one carrier, of the plurality of carriers, to a corresponding PSFCH resource based on a carrier identifier (ID) of the at least one carrier and a number of member user equipments (UEs) receiving the groupcast communication.

12. The baseband processor of claim 1, wherein the SL communication is a groupcast communication, and wherein the HARQ feedback is a single negative acknowledgement (NACK) only transmission for decoding errors on any of the plurality of carriers.

13. The baseband processor of claim 1, wherein the SL communication is a groupcast communication, and wherein the HARQ feedback is a negative acknowledgement (NACK) only transmission configured to provide decoding errors on any of the plurality of carriers.

14. The baseband processor of claim 1, wherein a HARQ acknowledgement (ACK) message is communicated via any carrier of the plurality of carriers when the decoding error is not detected.

15. A user equipment (UE), comprising:
radio frequency (RF) circuitry; and
one or more processors configured to execute instructions stored in a memory to cause the UE to:
transmit, via the RF circuitry, a sidelink (SL) communication to another UE via a plurality of carriers;
determine physical SL feedback channel (PSFCH) resources on a single carrier for receiving hybrid automatic repeat request (HARQ) feedback corresponding to the SL communication;
receive the HARQ feedback via the SL PSFCH resources; and
re-transmit, via the RF circuitry, the SL communication via the plurality of carriers in response to the HARQ feedback.

16. The UE of claim 15, wherein the PSFCH resources are an SL PSFCH primary cell that is determined based on a pre-defined rule.

17. The UE of claim 15, wherein the PSFCH resources are an SL PSFCH primary cell that is determined based on a resource pool pre-configuration or bandwidth part (BWP) pre-configuration.

18. The UE of claim 15, wherein the PSFCH resources are determined based on a total number of PSFCH resources and a number of the plurality of carriers.

19. A method, for a used equipment (UE), comprising:
transmitting a sidelink (SL) communication to another UE via a plurality of carriers;
determining physical SL feedback channel (PSFCH) resources on a single carrier for receiving hybrid automatic repeat request (HARQ) feedback corresponding to the SL communication;
receiving the HARQ feedback via the SL PSFCH resources; and
re-transmitting the SL communication via the plurality of carriers in response to the HARQ feedback.

20. The method of claim 19, wherein the PSFCH resources are an SL PSFCH primary cell that is determined based on a pre-defined rule.
